(19) United States
(12) Patent Application Publication
(10) Pub. No.: US 2019/0378425 A1
(43) Pub. Date: Dec. 12, 2019

(54) BEANBAG WITH DISPLAY APPARATUS

(71) Applicant: SitSpots, LLC, SAN CLEMENTE, CA (US)

(72) Inventor: JOYCE UTTERBACK BUEHLER, SAN CLEMENTE, CA (US)

(73) Assignee: SitSpots, LLC, SAN CLEMENTE, CA (US)

(21) Appl. No.: 16/006,078

(22) Filed: Jun. 12, 2018

(51) Int. Cl. G09B 3/00; G09B 1/02

(52) U.S. Cl. CPC G09B 3/00; G09B 1/02

(57) ABSTRACT

A beanbag including at least one transparent pocket formed thereon, the latter for receiving and displaying artwork or indicia, such as alphabetical letters, numbers, words and the like, for use in a variety of educational applications. The beanbag comprises a conventional beanbag formed from two like-sized pieces of fabric sewn to one another and operative to define an interior for holding a bean-like material, such as plastic pellets, actual dried beans, and the like. At least one transparent pocket is formed upon the beanbag that defines a window through which the educational indicia may be selectively positioned and displayed. The beanbag may take a variety of geometric shapes, and the beanbag may be configured to have multiple transparent windows for selectively displaying multiple images. In use, the user need only selectively replace the images sought to be displayed for a given application.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention is directed to modified beanbags for use in education, and more particularly, beanbags having display capabilities formed thereon to facilitate learning and providing instructors with means to selectively display educational indicia on the beanbag to provide for a more versatile educational tool.

Small beanbags are used in school classrooms for skills practice. Currently, such beanbags are printed with one word, letter or number on one side of the beanbag so that the child can match the word, letter, etc. printed on the beanbag to the content on the floor consisting of the same word or letter; similar to matching words/letters on a school worksheet.

The problem with such beanbags is that they are printed with only one word, letter, number or image and can only be used for just that purpose. In this regard, each printed beanbag can only be used for one specific piece of information, e.g., word or letter and inoperable for any other skill and once students master the limited instructional content printed on the beanbags, the beanbag is no longer useful. As a consequence, users/teachers are limited to using each beanbag for teaching that one skill (word/letter), and nothing further. For example, the US alphabet requires 26 different beanbags to be purchased and stored; and once students master learning their alphabet, these beanbags will not be used again (and must be stored). A classroom teacher thus needs to purchase and store hundreds, if not thousands, of printed one-word/letter beanbags in order to provide the needed content for skills practice and building fluency.

Moreover, printed beanbags in the current marketplace provide users with extremely limited content selection e.g., (color words, numbers and/or alphabet letters). Instructional content such as vocabulary words, geographical terms, and the like is nonexistent and not available. Unfortunately, despite the well-known effectiveness of utilizing beanbags to teach a variety of concepts, the sheer lack of beanbags that are operative to convey expanded topics and subject matter, such as geographic information, and the like, substantially limits the effectiveness of the beanbag that would otherwise be an outstanding teaching tool.

There is thus a need in the art for a beanbag that can be utilized for educational purposes that is more versatile and allows for greater variability in terms of displaying educational content. There is further need in the art for such a beanbag that is of simple construction, low cost, very easy to manipulate, can be utilized by small children and has the ability to easily and readily substitute educational materials displayed thereon to thus enable the beanbag to serve a more useful and versatile teaching tool.

### BRIEF SUMMARY

The present invention specifically addresses and alleviates the above-identified deficiencies in the art. In this regard, the present invention is directed to conventional hand-held beanbags that include means for displaying artwork, educational indicia, symbols, letters and the like for use in educational applications.

According to a preferred embodiment, the beanbag will comprise a conventional beanbag that is provided with at least one transparent pocket formed on at least one side thereof, the pocket being designed and configured to releasably hold and display therethrough an imprinted image or indicia, such as numbers, letters, symbols or other useful information designed to facilitate the educational process. To that end, it is contemplated that the at least one transparent pocket will be formed from a transparent plastic material through which the printed image can be displayed and seen. In use, the user need only insert the desired image to be displayed through the at least one transparent pocket and thereafter the beanbag utilized per conventional educational practices to convey the concept sought to be taught to the student, such as the value of a number, the pronunciation of a particular letter, and the like.

As will be readily appreciated by those skilled in the art, the beanbag may take any of a variety of shapes and sizes, and may be formed to have a generally square, generally rectangular, generally circular, generally triangular, generally pentagonal, generally hexagonal, generally heptagonal, generally octagonal, generally star-shape or any of a variety of geometric configurations well-known to those skilled in the art. Likewise, the at least one window display may be formed from a clear plastic material and simply sewn onto a respective side or sides of the beanbag so as to achieve the dual purpose of defining a pocket for holding the item of indicia sought to be displayed therethrough, as well as position the indicia so it can be easily and readily seen so as to facilitate the educational learning objective. In certain embodiments, the plastic material may be designed to be written on, such as by dry-erase markers and the like. Accordingly, it is contemplated that the beanbag with display apparatus of the present invention may be easily and readily fabricated using known materials, conventional beanbag construction and low-cost printed materials that will thus serve to accomplish a variety of educational tasks.

In further refinements of the present invention, the beanbag may further be integrated with additional mechanisms known in the art. Specifically, it is contemplated that the beanbags with display apparatus can include additional items such as a timer, an alarm indicating a correct or incorrect answer and/or a co-locational spatial sensor to thus enable multiple beanbags to be identified by position relative either other like beanbags and/or other fixed or variable locations.

It is therefore the object of the present invention to achieve the following:

The beanbags of the present invention will be cost effective, as it will not require hundreds of beanbags with permanent markings formed thereon to be purchased and stored for practicing skills.

The beanbags of the present invention provide users with the ability to display any content onto the beanbags and not be limited to what is currently available in the marketplace.

The beanbags of the present invention allow for continuous use of the same beanbags for teaching a wide variety of subjects and thus reduces cost and storage.

The beanbags of the present invention allow the user to determine the instructional content needed for skills practice and does not require a new beanbag for every new skill.

### BRIEF DESCRIPTION OF THE DRAWINGS

These as well as other features of the present invention will become more apparent upon reference to the drawings.

FIG. 1 is a frontal, exploded view of a beanbag with display apparatus constructed in accordance with a preferred embodiment of the present invention shown operative to receive and display a card bearing an image of the letter “A.”

FIG. 2 is a cross-sectional view taken along line 2-2 of FIG. 1.

FIG. 3 is a frontal view of the beanbag with display apparatus of Figure shown receiving and holding the card bearing the image of the letter “A” as shown for use in educational purposes.

FIG. 4 is a beanbag with display apparatus constructed in accordance with another preferred embodiment wherein the beanbag is shown assuming a circular configuration and displaying an image of the number “1”.

FIG. 5 is a beanbag with display apparatus constructed in accordance with another preferred embodiment wherein the beanbag is shown assuming a generally star-shaped configuration and displaying an image of the number “1”.

FIG. 6 depicts another alternative embodiment of the beanbag with display apparatus of the present invention wherein the beanbag is shown displaying an image of an “apple” and the beanbag is formed to have a generally triangular configuration.

### DETAILED DESCRIPTION

The detailed description set forth below is intended as a description of the presently preferred embodiment of the invention, and is not intended to represent the only form in which the present invention may be implemented or performed. The description sets forth the functions and sequences of steps for practicing the invention. It is to be understood, however, that the same or equivalent functions and sequences may be accomplished by different embodiments and that they are also intended to be encompassed within the scope of the invention.

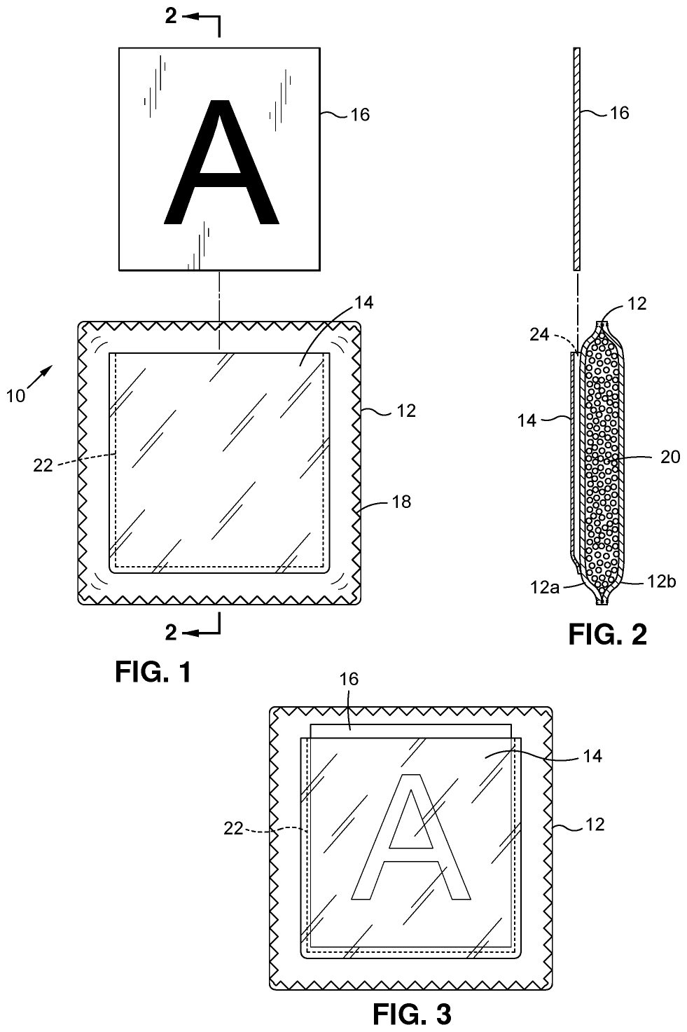

Referring now to the figures, and initially to FIG. 1, there is shown a beanbag with display apparatus 10 as constructed in accordance with a preferred embodiment of the present invention. As illustrated, the beanbag with display apparatus 10 includes a beanbag portion 12 having at least one transparent pocket 14 formed thereon, the latter for receiving and displaying educational indicia for use in educational applications. As shown in FIG. 1, exemplary of the educational indicia includes the letter “A” that is printed on a card 16 and operative to be inserted within transparent pocket 14 discussed more fully below. As will be readily understood and appreciated by those skilled in the art, the educational indicia, such as the letter “A” may take any of a variety of forms, and may include not only letters, but numbers, words, symbols, prefixes, suffixes, geographic information or any type of subject matter that may be readily conveyed through visual perception.

With respect to the construction of the beanbag 12, the same may take any of a variety of forms well-known to those skilled in the art. Referring to both FIGS. 1 and 2, the beanbag portion 12 may comprise the combination of first and second panels of fabric 12a, 12b, that are sewn together via stitching 18, shown in FIG. 1. Disposed between fabric panels 12a, 12b are any of a variety of beanbag materials 20, which may include plastic pellets, actual dried pinto beans, or any of a variety of safe and non-toxic materials well-known to those skilled in the art. Disposed upon at least one side of the beanbag 12 will be the transparent pocket 14, which in the embodiment shown will have three sides thereof stitched, via stitching 22 shown in FIG. 1, to thus secure the transparent pocket 14 to at least one side 12a of the beanbag 12 and defining a pocket 24 through which the card displaying educational indicia 16 may be inserted.

While it is understood that any of a variety of geometric shapes and configurations may be utilized in the practice of the present invention as discussed below, the embodiment 10 shown depicts a generally square shaped beanbag. Although readily apparent to those skilled in the art, to fabricate such embodiment, the fabric panels 12a, 12b are initially cut into squares. The transparent pocket 14 is preferably made from clear vinyl and is sewn onto one side 12a of the fabric. Alternatively, two pockets 14 can be sewn onto respective sides 12a, 12b for a 2-sided clear pocket beanbag, leaving one side open to serve as a pocket. The fabric panels 12a, 12b of the beanbag 12 are sewn together on three sides and stuffed with plastic pellet bean material 20 then sewn and closed off on the remaining side.

In a most preferred embodiment, the fabric is cut into 115 mm squares (or larger 13 or 15 mm). The clear vinyl pocket 14 is cut into a 90 mm square or larger for larger sizes. Each beanbag requires at least one clear pocket 14, although multiple pockets can be fixed to one or both sides 12a, 12b of the beanbag 12 as may be desired. The pocket 14 is centered and sewn (overstitched) on 3 sides only of one side 12a (two sides 12a, 12b, for 2-sided clear pocket beanbag) of the fabric; leaving one side open creating the pocket. Both sides of the fabric are joined together evenly and overstitched on 3 sides. Plastic pellets 20 are used for the stuffing material of the beanbag. Once placed inside, the unstitched section of the beanbag is overstitched and closed off.

The transparent vinyl pocket 14 enables users to place and display pre-printed content inside the pocket 14. This gives the users the ability to change the printed content when needed by removing and replacing it from the clear pocket.

To that end, the user would determine the instructional content (e. g., letter, word, mathematical equation, etc.) and print it onto a piece of paper that would fit into the display pocket 14 of this beanbag 12. Once printed, the user would insert the printed into the pocket with the printed side displaying through the clear pocket. The user would then determine the use for the beanbag for skills practice with students. The user can then replace the content when desired using the same process.

In use, and as depicted in FIG. 3, the letter “A” as printed on 16 will be displayed through transparent pocket 14 by virtue of the pocket being defined thereby via stitching 22. When in such configuration, the beanbag 12 with educational material 16 displayed therethrough may be utilized for a variety of teaching applications.

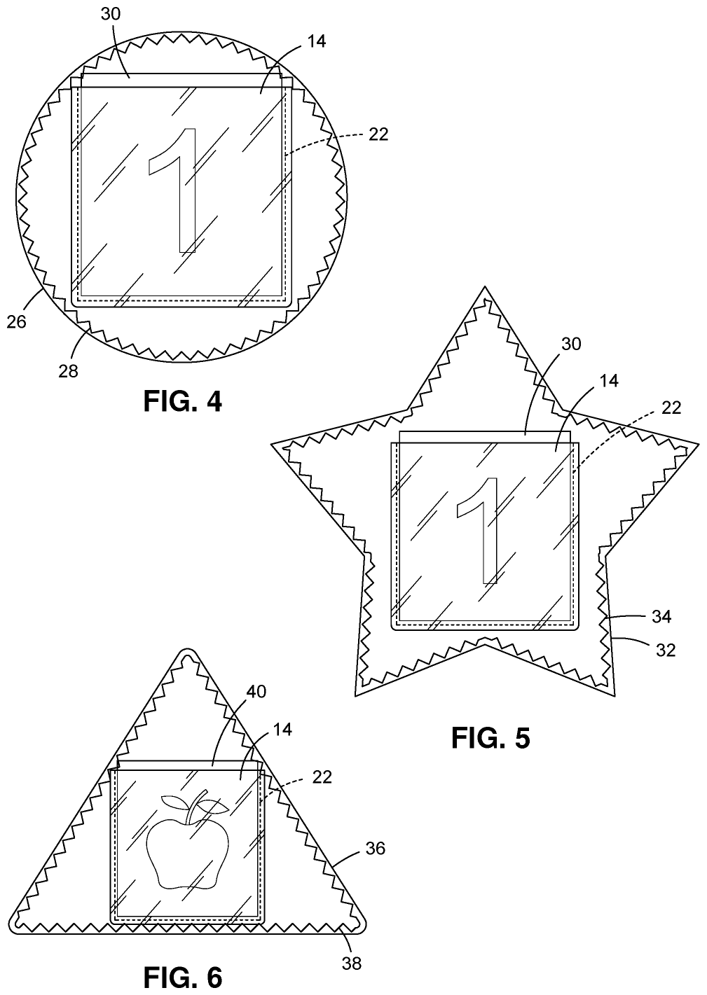

Referring now to FIGS. 4-6, and initially to FIG. 4, the beanbag with display apparatus according to the present invention may take a variety of geometric shapes and sizes. As depicted in FIG. 4, the beanbag 26 is shown assuming a circular configuration yet retains the transparent pocket 14 stitched thereto via stitching 22 and thus operative to receive educational indicia 30, the latter showing the number “1” as shown. Per the exceedingly simple construction discussed above, the circular configuration of the beanbag 26 will simply comprise the mating of two contiguous pieces of circular fabric sewn together at the outer circumference thereof via stitching 28 to thus define an interior pocket into which the bean material 20 will be stored. The transparent pocket 14 will be stitched to a respective side of circular beanbag 26 as shown. As discussed above, it will be understood that transparent pockets may be formed on both sides of the beanbag 26 or, alternatively, multiple pockets may be formed on one or both sides of the beanbag 26 as may be desired for a particular teaching application. In all such applications, however, it will be understood that the transparent pocket 14 will be operative to releasably secure and display educational indicia as may be desired for a particular application.

Referring now to FIG. 5, the beanbag with display apparatus according to the present invention is shown assuming a generally five-point star configuration 32. According to such embodiment 32, the same will likewise include two like sized star-shaped panels of fabric sewn to one another per stitching 34 to thus define the beanbag into which the filler material 20 (not shown) will be positioned. As per the other aforementioned embodiments, the transparent pocket 14 may be formed on one or both respective sides of the star-shaped beanbag 32 via stitching 22 around three sides thereof to thus define an opening of the pocket through which educational indicia 30 may be selectively positioned and displayed.

Referring now to FIG. 6, there is yet a further embodiment of the beanbag with display apparatus of the present invention shown assuming a generally triangular shape 36. Per the other aforementioned embodiments, the embodiment depicted in FIG. 6 will simply comprise the mating of two like-sized triangular panels of fabric sewn around the periphery thereof via stitching 38 and operative to define a surface area onto which transparent pocket 14 may be attached via stitching 22 around three sides thereof to thus define the display window into which educational material, such as an “apple” 40 shown, may be selectively positioned and displayed so as to facilitate teaching a given concept.

As will be readily appreciated by those skilled in the art, and as mentioned above, it should be readily understood that the beanbag with display apparatus may take a variety of other shapes and sizes as may be desired for a given application. For example, the beanbag may be formed to have a generally rectangular shape, a generally pentagonal shape, a generally hexagonal shape, a generally heptagonal shape, a generally octagonal shape and/or a generally pocket shape, among numerous others. In addition, although depicted as having only one pocket formed on a respective side of each beanbag, it will be understood that the display pocket 14 may take a variety of forms, and may include multiple pockets or even may comprise a material that may not only be transparent, but also capable of being written on, such as through dry erase markers and the like, to thus enable an instructor to make notes or write upon the window display defined by transparent pocket 14 to yet further increase the versatility of the beanbag with display apparatus of the present invention to be utilized in educational applications.

In yet further refinements of the present invention, it is contemplated that the beanbags with display apparatus according to the present invention may be integrated with other well-known components and teaching tools to thus further enhance its usage and versatility in teaching applications. For example, it is contemplated that the beanbags of the present invention may be integrated with a timer to thus enable the beanbag with display apparatus to be utilized in timed response applications, and further may include an alarm or signaling device so as to indicate either a correct answer or an incorrect answer has been made by a particular student.

It is further contemplated that in some applications, the beanbag may be integrated with known electronics extensively utilized in the art, such as the use of co-locational spatial sensors to thus enable multiple beanbags to be identified by position relative either other like beanbags and/or other fixed or variable locations. Along those lines, by inserting co-locational spatial sensor into the beanbag, the sensor may be able to identify with a paired sensor located on a specific marking on the floor of a classroom when in close proximity interacting with a software program.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

What is claimed is:

1. A beanbag with display apparatus comprising:
a. a beanbag formed from two like sized panels of fabric stitched to one another, said panels of fabric stitched to one another defining an interior to hold a bean-type material;
b. a bean-type material disposed within said interior of said like panels of fabric stitched to one another; and
c. at least one transparent pocket fastened upon a respective side of at least a respective one of said panels of fabric, said transparent pocket being operative to selective receive and display a sheet of material having printed indicia formed thereon.

2. The beanbag of claim 1 wherein said beanbag is formed from like-sized panels of material and operative to define a shape selected from the group consisting of square, rectangle, circle, star, triangle, pentagon, hexagon, heptagon, octagon and pocket shape.

3. The beanbag of claim 1 wherein said transparent pocket is formed from a clear vinyl plastic.

4. The beanbag of claim 3 wherein said clear vinyl plastic is stitched upon a respective one of said panels of fabric of said beanbag.

5. The beanbag of claim 3 wherein said clear vinyl plastic is further operative to be marked upon by dry erase ink with said dry erase ink being removable therefrom.

6. The beanbag of claim 1 wherein said beanbag further includes a timer integrated therein.

7. The beanbag of claim 1 wherein said beanbag includes an alarm mechanism integrated therein, said alarm being operative to provide a first signal corresponding to a correct answer and a second signal corresponding to an incorrect answer.

8. The beanbag of claim 1 wherein said beanbag includes a co-locational spatial sensor integrated therein for communicating with at least one second co-locational spatial sensor.

9. The beanbag of claim 1 wherein said indicia positioned to be displayed through said transparent window is selected from the group consisting of a letter, a number, a word, a picture, and a geographic location.
